(19) United States
(12) Patent Application Publication
(10) Pub. No.: US 2012/0055032 A1
(43) Pub. Date: Mar. 8, 2012

(54) HEDGE TRIMMER

(75) Inventors: Andrew Roise, North Lincolnshire (GB); Keith Park, York (GB)

(73) Assignee: CHERVON (HK) LIMITED, Wanchai (HK)

(21) Appl. No.: 13/213,290

(22) Filed: Aug. 19, 2011

(30) Foreign Application Priority Data
Sep. 3, 2010 (CN) 201010271701.0

(51) Int. Cl. A01G 3/053

(52) U.S. Cl. 30/216; 30/208

(57) ABSTRACT

A hedge trimmer having improved operational balance includes a housing with a front handle and a main handle, a cutting assembly, a motor assembly, a transmission assembly and a switch device arranged on the housing for controlling the start of the motor assembly. The cutting assembly is connected to the housing, the motor assembly and the transmission assembly are arranged in the housing, and the transmission assembly for transmitting the rotation of the motor assembly to the cutting assembly is located between the motor assembly and the cutting assembly. The main handle is located between the motor assembly and the transmission assembly and a main part of the main handle is located above a motor output shaft in the motor assembly.

RELATED APPLICATION DATA

This application claims the benefit of 201010271701.0, filed on Sep. 3, 2010, the disclosure of which is incorporated herein by reference in its entirety.

### BACKGROUND

The following generally relates to garden tools and, more particularly, to a hedge trimmer.

A hedge trimmer is an electrical tool commonly used in gardens and may be used to cut or trim shrubs or hedges. As people become more environmentally conscious, the hedge trimmer is more and more widely used. The advantages of the hedge trimmer include its high efficiency, convenient usage, etc.

However, the motor and the gearbox transmission mechanism of a conventional hedge trimmer are located at the front side of the main handle. Therefore, the weight of the whole tool is concentrated at the portion between the main handle and the cutting assembly. This weight distribution may affect the balance of the whole tool and the comfort of operators during operation.

### SUMMARY

The following describes a hedge trimmer having improved weight balance which enables the operator to operate the hedge trimmer more comfortably.

More particularly, the hedge trimmer includes a housing with a front handle and a main handle, a cutting assembly, a motor assembly, a transmission assembly, and a switch device arranged on the housing for controlling the start of the motor assembly. The cutting assembly is connected to the housing; the motor assembly and the transmission assembly are arranged in the housing; and the transmission assembly for transmitting rotation of the motor assembly to the cutting assembly is located between the motor assembly and the cutting assembly. The main handle is located between the motor assembly and the transmission assembly, and the main part of the main handle is located above a motor output shaft of the motor assembly.

The transmission assembly, the main handle, and the motor assembly may be arranged along a common line.

A transmission shaft for transmitting the rotation of the motor output shaft in the motor assembly to the transmission assembly may be arranged between the transmission assembly and the motor assembly. The transmission shaft may thus pass through the main handle and be disposed above the motor output shaft.

From the foregoing, it will be appreciated that, because the main handle of the hedge trimmer is disposed between the motor assembly and the transmission assembly, a portion of the weight is distributed to the rear side of the main handle and the balance of the integral hedge trimmer may be enhanced. Furthermore, as the handle is located above the motor output shaft, raising of the rear end of the hedge trimmer may be avoided during operation. Moreover, with the transmission shaft being disposed above the motor output shaft, enough handling space for the operator is provided even when a small motor is adopted thus further enhancing the operating comfort of the operator.

### BRIEF DESCRIPTION OF DRAWINGS

The subject trimmer will be described with reference to the following figures in which:

FIG. 1 is a schematic view of an exemplary hedge trimmer constructed according to a described embodiment;

FIG. 2 is a partial sectional view of the hedge trimmer in FIG. 1;

FIG. 3 is a complete sectional view of the hedge trimmer in FIG. 1;

FIG. 4 a is a front view of the switch device of the hedge trimmer in FIG. 1 which is in the off-state;

FIG. 4b is a front view of the switch device of the hedge trimmer in FIG. 1 which is in the on-state; and

FIG. 4c is a three-dimensional view of the switch device in the on-state.

### DETAILED DESCRIPTION

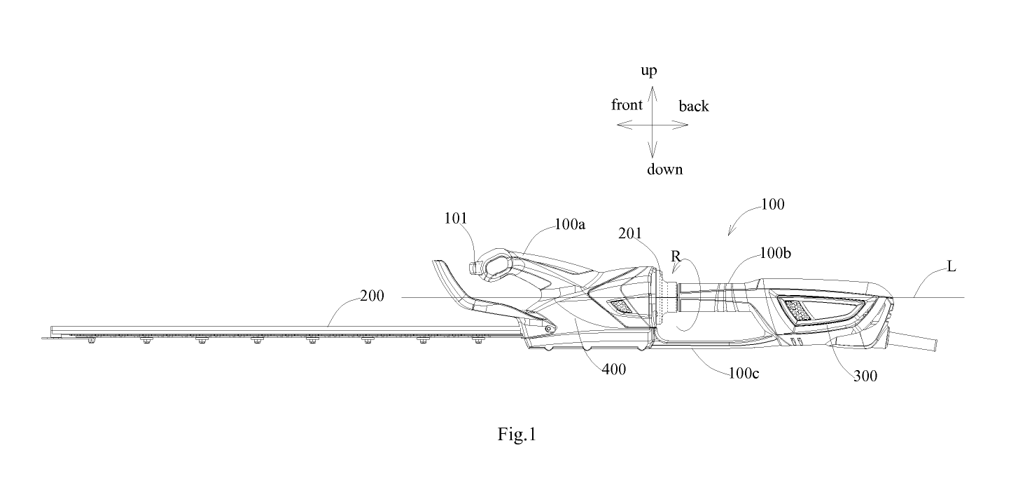

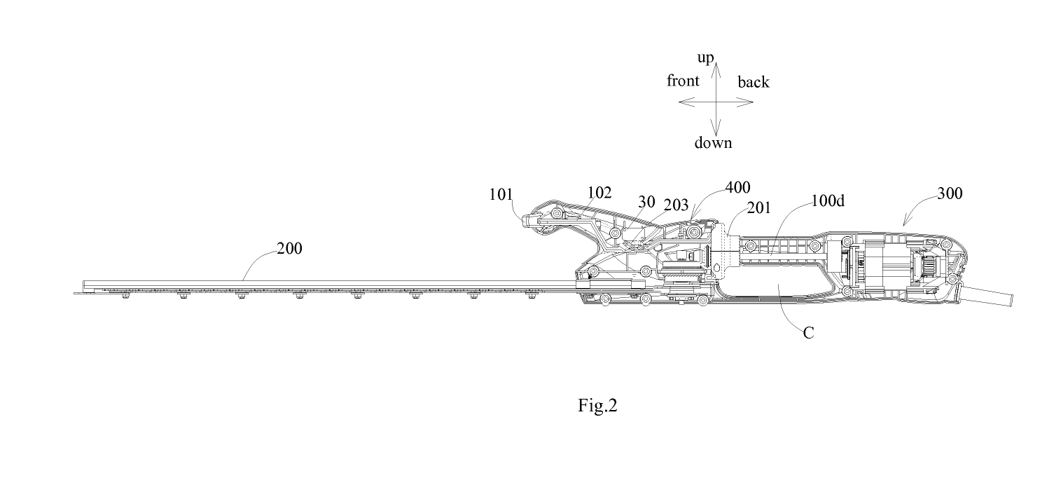

Referring to FIGS. 1-4c, a hedge trimmer includes a housing 100, a cutting assembly 200, a motor assembly 300, a transmission assembly 400 and a switch device 500. The housing 100 includes a front handle 100a and a main handle 100b; the cutting assembly 200 is connected to the housing 100; the motor assembly 300 is arranged in the housing 100; the transmission assembly 400 for transmitting the rotation of the motor assembly to the cutting assembly is arranged in the housing 100 and located between the motor assembly 300 and the cutting assembly 200. To the persons skilled in the art, the construction of the cutting assembly 200, the motor assembly 300, the transmission assembly 400, and the switch device 500—particularly as used to control the motor assembly 300—is common knowledge, therefore detailed description are omitted herein.

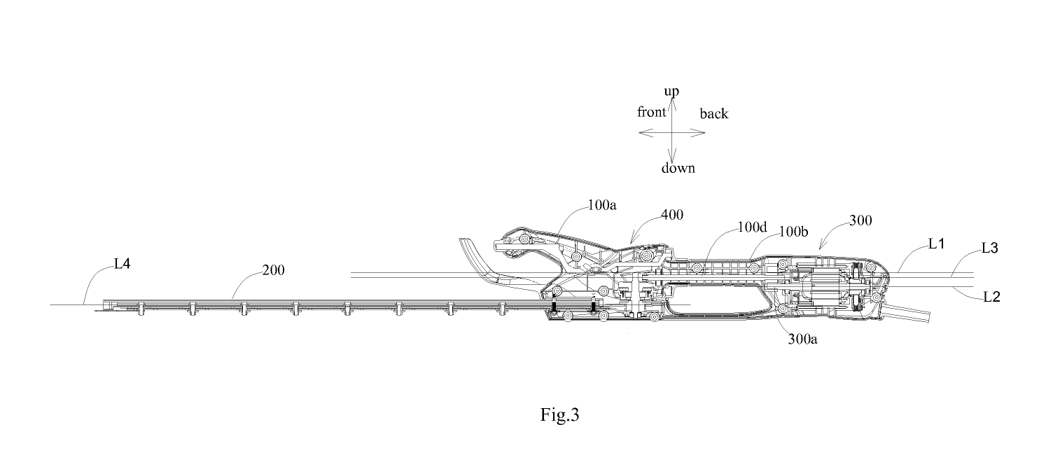

In the present embodiment, the main handle 100b is disposed between the motor assembly 300 and the transmission assembly 400. Further, as shown in FIG. 3, the main handle 100b has an axis L1 which is positioned above an axis L2 of a motor output shaft of the motor assembly 300.

Furthermore, the transmission assembly 400, the main handle 100b and the motor assembly 300 are arranged to be passed by a common line, therefore it is helpful to enhance the balance of the whole hedge trimmer. Moreover, in the present embodiment, the housing 100 of the hedge trimmer also includes a strengthening rod 100c which enables the portion for accommodating the transmission assembly 400 and the portion for accommodating the motor assembly 300 of the housing 100 to be connected more stably. A transmission shaft 100d is arranged between the transmission assembly 400 and the motor assembly 300. The transmission shaft 100d is arranged to pass through the main handle 100b for transmitting the rotation of the motor output shaft 300a in the motor assembly 300 to the transmission assembly 400. An axis L3 of the transmission shaft 100d is positioned above the axis L2 of the motor output shaft 300a. The advantage of such configuration is that handling space C for the operator is provided even though the small motor is used in the hedge trimmer, and further operating comfort of the operator is enhanced. In the present embodiment, the motor assembly is mainly located above an axis L4 along the length direction of the cutting assembly 200.

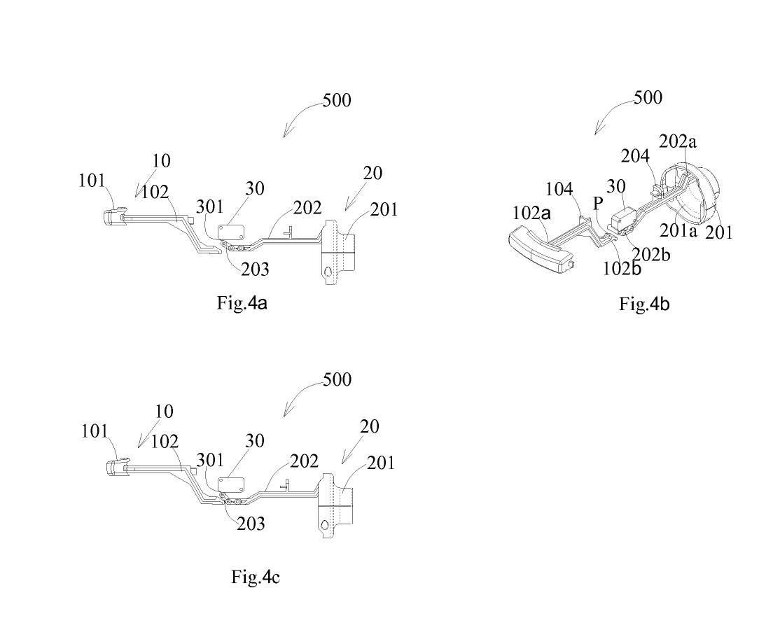

The switch device 500 includes a front operating portion 10 arranged on the front handle 100a of the hedge trimmer, a rear operating portion 20 arranged on the main handle 100b of the hedge trimmer, and a switch element 30. The front operating portion 10 has two positions which are near to or far from the rear operating portion 20 respectively, and the rear operating portion 20 has two positions which are near to or far from the front operating portion 10. The front operating portion 10 includes a front pressing portion 101 and a front connecting rod 102, the front pressing portion 101 is disposed on the first end 102a of the front connecting rod 102 and the front connecting rod 102 is moved with the front pressing portion 101. The rear operating portion 20 includes a rear pressing portion 201, a rear connecting rod 202 and a driving rod 203, the rear pressing portion 201 is disposed on the first end 202a of the rear connecting rod 202 and extends along the circumferential direction of the main handle 100b, and the rear connecting rod 202 is moved with the rear pressing portion 201. As shown in FIG. 4b, the rear pressing portion 201 also has a collar 201a for driving the rear connecting rod 202 to move forwards. The driving rod 203, pivotally connected to the second end 202b of the rear connecting rod 202, has a first position at which the switch element 30 is in the off-state and a second position at which the switch element 30 is in the on-state. In the present embodiment, the driving rod 203 is angled at 0 degree with respect to the horizontal plane when it is located at the first position. Furthermore, the other end 102b of the front connecting rod 102 has a slope P of 45 degrees for adapting to the inclined driving rod 203. The front pressing portion 101 is T-shaped, and the rear pressing portion 201 is annular and surrounds the circumference surface of the main handle 100b. However, the present invention does not be limited to this embodiment, and in other embodiments, the rear pressing portion 201 may be a half or quarter annular shape, or other pressing elements.

In use, the switch element 30 is in the off-state initially. As shown in FIG. 4a, the pressing portion 101 of the front operating portion 10 is not pressed down, that is, the front operating portion 10 is in the position far from the rear operating portion 20. At this moment, if the rear pressing portion 201 is pushed forward, the rear connecting rod 202 will move forwards under the driving of the rear pressing portion 201, and the driving rod 203 will also move forward along the slope P and will not contact a triggering portion 301 of the switch element 30, therefore the driving rod 203 will not apply a force to the triggering portion 301. At this moment, the switch element 30 cannot be switched on to activate the hedge trimmer.

When the switch element 30 is to be switched on, the front pressing portion 101 is pressed down firstly, that is, the front operating portion 102 moves towards the position near the rear operating portion 20, and then the rear pressing 201 is pushed forwards. While being pushed forward, the driving portion 203 may be blocked by the end portion 102b of the front operating portion 102, therefore, the driving portion 203 may rotate towards the rear side. When the rear operating portion 20 moves to the position near the front operating portion 10, the driving portion 203 rotates to a position angled at 45 degrees with respect to the horizontal plane, and the force applied on the triggering portion 301 is enough to switch on the switch element 30 for starting the hedge trimmer.

The hedge trimmer may also include a front fastener 104 and a rear fastener 204 for fastening the front operating portion 10 and the rear operating portion 20 to the housing 100 respectively. Additionally, the hedge trimmer may include a front restoring assembly and a rear restoring assembly for resetting the front operating portion 10 and the rear operating portion 20 after the operator releases the device, thereby switching off the switch element 30 of the hedge trimmer. Furthermore, because the rear pressing portion 201 is annular, the operator may switch on the hedge trimmer by applying a force to any positions of the rear pressing portion 201, This enables the operator to switch on the hedge trimmer easily even if the main handle 100b is held from different directions. That is to say, the operator may operate the switch of the hedge trimmer easily when the hedge trimmer is rotated; moreover, the hedge trimmer can be operated normally when the operator rotates the hedge trimmer, therefore it enables the operator to adjust the trimming surface of the hedge trimmer without having to shut down the hedge trimmer.

In summary, the main handle of the hedge trimmer is disposed between the motor assembly and the transmission assembly, therefore a portion of the weight is distributed to the rear side of the main handle, and the balance of the integral hedge trimmer may be enhanced. Moreover, with the transmission shaft being located above the motor output shaft, enough handling space may be provided for the operator even when a small motor may be used in the hedge trimmer. This arrangement also enhances the operating comfort of the operator. Due to the annular rear pressing portion, the operator can switch on the hedge trimmer easily even if the main handle is held from different directions, that it to say, the operator may operate the switch of the hedge trimmer easily when the hedge trimmer is rotated. Moreover, the hedge trimmer can be operated normally when the operator rotates the hedge trimmer, thus it enables the operator to adjust the trimming surface of the hedge trimmer without shutting down the hedge trimmer.

The embodiment described herein is just one preferable embodiment of the invention and it is not intended to limit the scope of the invention. That is to say, equivalent changes and modifications according to the contents of the invention may be regarded as falling within the technical scope of the invention as defined by the claims which follow.

What is claimed is:

1. A hedge trimmer, comprising:
a housing having a front handle and a main handle;
a cutting assembly;
a motor assembly;
a transmission assembly and
a switch device arranged on the housing for controlling the motor assembly;
wherein the cutting assembly is connected to the housing; the motor assembly and the transmission assembly are arranged in the housing; the transmission assembly is located between and couples the motor assembly to the cutting assembly; the main handle is located between the motor assembly and the transmission assembly; and a main part of the main handle is located above a motor output shaft of the motor assembly.

2. The hedge trimmer according to claim 1, wherein the transmission assembly, the main handle, and the motor assembly are arranged on a common line.

3. The hedge trimmer according to claim 2, wherein a transmission shaft for transmitting the rotation of the motor output shaft of the motor assembly to the transmission assembly is arranged between the transmission assembly and the motor assembly and passes through the main handle.

4. The hedge trimmer according to claim 3, wherein the transmission shaft is further than the motor output shaft from a line which includes the cutting assembly.

5. The hedge trimmer according to claim 1, wherein the motor assembly is spaced from a line which includes the cutting assembly.

6. The hedge trimmer according to claim 1, wherein the hedge trimmer is supplied with an AC electric power.
